(19) United States
(12) Patent Application Publication
(10) Pub. No.: US 2023/0194736 A1
(43) Pub. Date: Jun. 22, 2023

(54) SYSTEM AND METHOD FOR ROBUST SEISMIC IMAGING

(71) Applicant: Chevron U.S.A. Inc., San Ramon, CA (US)

(72) Inventors: Yue Wang, Sugar Land, TX (US); Peng Shen, Katy, TX (US); Yang Luo, Houston, TX (US)

(21) Appl. No.: 17/553,606

(22) Filed: Dec. 16, 2021

(51) Int. Cl. G01V 1/28; G01V 1/34

(52) U.S. Cl. CPC G01V 1/282; G01V 1/34; G01V 2210/512; G01V 2210/679

(57) ABSTRACT

A method is described for seismic imaging including receiving a pre-stack seismic dataset and an earth model at one or more computer processors; performing least-squares reverse time migration of the pre-stack seismic dataset using the earth model to create a digital seismic image, wherein the least-squares reverse time migration includes wave-equation forward modeling based on an asymptotic expression for reflection in a subsurface Kirchhoff integral; and generating a display of the digital seismic image on a graphical user interface.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for seismic imaging of the Earth's subsurface.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for faster, more robust seismic imaging.

### SUMMARY

In accordance with some embodiments, a method of seismic imaging including receiving a pre-stack seismic dataset and an earth model; performing least-squares reverse time migration of the pre-stack seismic dataset using the earth model to create a digital seismic image, wherein the least-squares reverse time migration includes wave-equation forward modeling based on an asymptotic expression for reflection in a subsurface Kirchhoff integral; and generating a display of the digital seismic image on a graphical user interface is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for seismic imaging;

FIG. 2 demonstrates compares conventional methods with an embodiment of the present invention; and

FIG. 3 compares results of conventional reverse time migration with results of the present invention.

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to be of particular use for seismic imaging of prestack seismic data.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Wave-equation based least-squares reverse-time migration (LS-RTM) relies on proper forward simulation that maps synthetic angle-dependent reflectivity, in true amplitude, to data. The interaction between the incident waves and the Heaviside singularities embedded in the earth model gives rise to the primary reflection. The conventional Born modeling that acts on the synthetic reflectivity based on the Dirac delta singularity rather than the correct Heaviside singularities does not provide the correct physics to simulate the reflection data. To find the proper LS-RTM forward modeling, the present invention starts with the Born approximation acting on the medium perturbation that contains Heaviside singularities. This leads to the subsurface Kirchhoff integral. We directly calculate the stationary phase integral, inherited from the subsurface Kirchoff integral, by explicitly evaluating the determinant of the traveltime Hessian, arriving at an asymptotic expression of the primary reflection. We are, then, able to extract from it a proper forward modeling that linearly acts on the Dirac singularity which is used to represent the synthetic reflectivity. A portion of the present invention designs wave-equation forward modeling for LS-RTM in a way that is more robust and computationally less expensive than conventional LS-RTM methods.

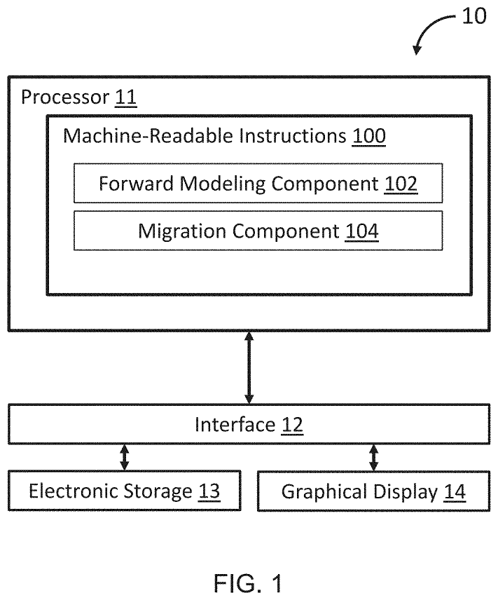

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. Processor 11 may be configured to receive prestack seismic data and to execute machine-readable instructions 100 in order to generate a seismic image using the LS-RTM method described below. The prestack seismic data may be synthetic data (i.e., seismic data computationally generated) or field data (i.e., seismic data recorded at physical seismic sensors).

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to seismic data, an earth model, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to seismic data, an earth model, seismic images, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate seismic imaging. The machine-readable instructions 100 may include one or more computer program components. The machine-readable instructions 100 may include a forward modeling component 102, a migration component 104, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the forward modeling component 102 and the migration component 104 work together as a single iteration of least-squares reverse time migration. The forward modeling component 102 and the migration component 104 may be repeatedly implemented to perform multiple iterations of LS-RTM in order to continue improving the resulting seismic image. In the present invention, the forward modeling is based on an asymptotic expression for the reflection that is derived from the subsurface Kirchhoff integral and the stationary phase integral. As is known to those of skill in the art, LS-RTM, the computation can be simplified by the use of the Hessian to approximate the diagonal of L′L, which is the combination of migration L′ and forward modeling L. In an embodiment, this Hessian may be computed in the curvelet domain using a multi-scale curvelet transform. In order to derive an asymptotic expression for the forward modeling, a step of the present invention evaluates the determinant of the traveltime Hessian ∇∇T(x₀), which is the matrix of the second order derivative of the traveltime with respect to x₁ and x₂ evaluated at the stationary scattering point x₀. The determinant of the Hessian becomes:

$$det ( ∇ ∇ T ( {x}_{0} ) ) = \frac{4 {cos}^{2} {θ}_{0}}{{c}^{2} {l}_{0}^{2}}$$

where θ₀ is the reflection angle at the stationary scattering point, c is the acoustic (P-wave) velocity, and l₀ is the harmonic mean of the length of the source ray and the length of the receiver ray. This novel derivation of the determinant of the Hessian allows the novel asymptotic expression for reflection to be derived as:

$$δ G ( ω , r \vert 0 , s ) ∼ \frac{2 π {l}_{0}}{ρ} ( \frac{Δ c}{2 c {cos}^{2} {θ}_{0}} + \frac{Δ ρ}{2 ρ} ) {A}_{s} {A}_{r} {e}^{i ω T ( r , {x}_{0} , s )}$$

where G is the Green's function, ω is phase frequency, r is the receiver location, s is the source location, ρ is the density, Aₛ is the source amplitude and traveltime, Aᵣ is the receiver amplitude and traveltime, and T is the specular traveltime. This formulation results in the desired angle dependency with the correct spectrum, unlike conventional methods.

The equation above can be rewritten based on angle-based coefficients R(θ), which is the reflectivity at angle θ, the phase term ω, and the traveltime as τ:

G(s,r)=R(θ)AₛAᵣe^{iωτ}

The reflectivity angle θ has a relationship with subsurface offset gather. If the angle-based reflectivity gather is known, a τ-p based transformation can be applied to generate the subsurface offset gather. The adjoint operation can be applied to transform subsurface offset gather to angle gathers. Therefore, the equation above can have modeling performed in the subsurface offset (h) domain:

G(s,r)=R(h)Aₛ(xₛ+h)Aᵣ(xᵣ−h)e^{iωτ}

The forward τ-p transformation would produce R(h) from angle reflectivity model and the adjoint τ-p transformation would produce angle reflectivity gradient from subsurface offset gradient. This can also be expressed in terms of the image gathers (I) for angle θ and subsurface offset (h):

I(s,θ,x)=τ−p_transform(I(s,h,x)) Eq. 1

I(s,h,x)=τ−p_transform(I(s,θ,x)) Eq. 2

When subsurface offset gather is formed from migration process, it is possible to apply the previous τ-p operator to accomplish the transform from and to the angle reflectivity gather. Angle mapping from this transform might be used to replace the τ-p operator efficiently.

For a single shot subsurface offset gather, one reflection energy at a subsurface point has a specific reflection angle, and presents as a single plane wave in the single shot subsurface offset gather. The τ-p transform mentioned above would transform this plane wave to a peak in the angle gather. The peak position is the angle and depth of this reflection wave. The pairing of peak angle and spatial location can be used to form a subsurface angle gather more efficiently.

The simplest approach to this mapping is to pick the peak angle and location pairing. The picking is done on the Eq. 1 output. The information contained in this pick means that this source would migrate receiver data to this angle at this picked spatial position and angle. One can then only generate a regular migrated (e.g., reverse time migration) image with zero subsurface offset and then use the picked angle/spatial location pair to put each spatial local image to the angle bin.

If we denote I(s,x) is a single shot image with zero offset for source s and position x, M(s,θ,x) is picked pairing information, for shots s and position x, there is a pick at angle θ with value either 0 or 1. If it is 0, then no angle reflection from this position x for s. If the pick value is 1, it means this position has reflection for this angle.

Then the subsurface offset to angle gather transformation can be achieved by:

Step A1: Picking M(s,θ,x) based on I(s,θ,x) in equation 1 output above.

Step A2: I(s,θ,x)=M(s,θ,x)·I(s,x) Eq. 3

And its adjoint operator is:

Step A3: I(s,x)=M(s,θ,x)·I(s,θ,x) Eq. 4

The mapping M(s,θ,x) can be stored and reused. If we assume that this angle mapping M is smooth, we can computed M using a lower-frequency reverse time migration and subsurface offset formation. That would create an efficient algorithm for angle mapping computation and then applying this M from low frequency computations for high frequency angle formation in the later stage efficiently. No high frequency subsurface offsets are needed.

In an embodiment, a more robust approach was developed. Instead of picking each angle/location pair and limit the value in M to be either 0 and 1, one can directly manipulate the I(s,θ,x) in equation 1 to generate a map. This can be achieved by:

Step B1: instead of normal τ-p transform on subsurface offset image I(s,h,x), a semblance transform is applied to compute S(s,θ,x).
Step B2: normalize all the angle S values at each spatial location to get M(s,θ,x)
Then this improved semblance based M(s,θ,x) can be used to accomplish the forward and adjoint operation of Step A2 and Step A3.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

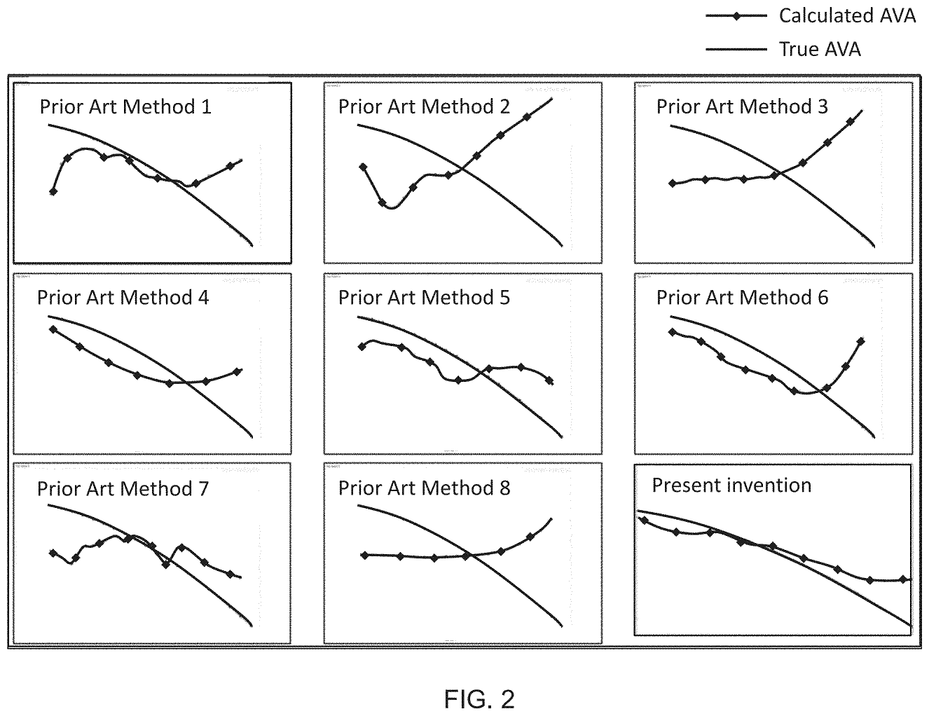

FIG. 2 compares the results of the present invention with eight prior art methods. The true amplitude variation with angle (AVA) curves are shown with the calculated AVA curves. As can be seen, the AVA calculated by the present invention is much more accurate than the prior art methods. This accuracy allows the LS-RTM method to converge more quickly, thereby significantly reducing the number of iterations needed to generate a well-focused seismic image.

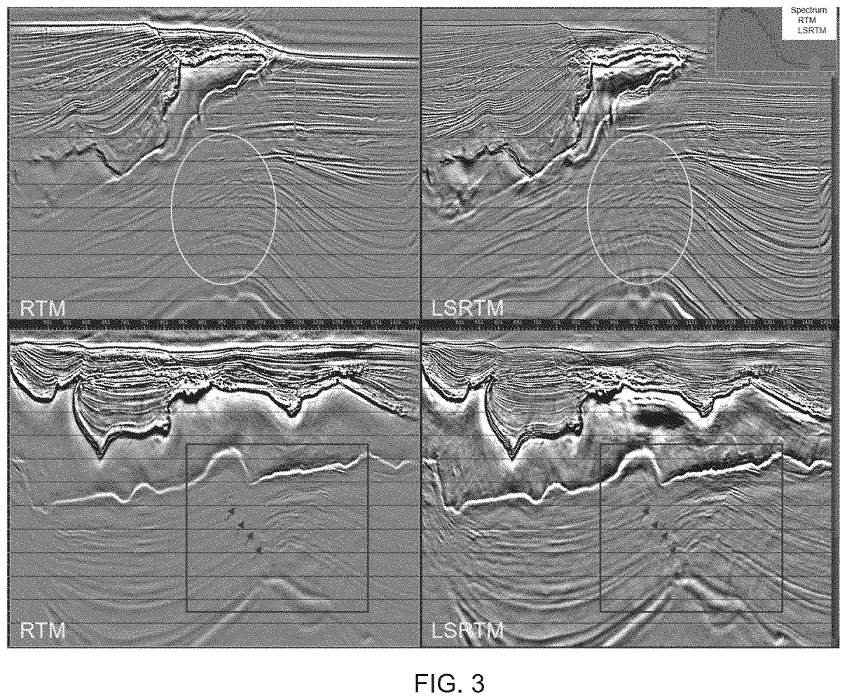

FIG. 3 compares the seismic images from conventional reverse time migration (RTM) in the left panels against seismic images generated by the present LS-RTM in the right panels. All of the images include a salt body and the regions of interest under the salt. The white ovals and black rectangles indicate areas where the improved focusing of the present LS-RTM allows subsalt structures including faults to be clearly seen.

As explained previously, all LS-RTM methods work with a non-physical reflectivity and so require modifications to the wave-equation in order to reproduce the correct angle and spectrum response for reflection in the LS-RTM forward modeling. Studies in the past have concentrated on the inverse transform based upon the subsurface Kirchhoff integral, so that through the inverse transform the true amplitude image is obtained in one-go from migration. A portion of the present invention, instead, obtains the asymptotic expression for the reflection from the subsurface Kirchhoff integral, so that the necessary angle and spectrum modification are extracted in order to properly construct the non-physical wave-equation for the LS-RTM forward modeling. The closed form expression of the determinant of the traveltime Hessian, assuming velocity with sufficient smoothness, becomes the key enabler for this task.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of seismic imaging, comprising:
a. receiving, at a computer processor, a pre-stack seismic dataset and an earth model;
b. performing least-squares reverse time migration of the pre-stack seismic dataset using the earth model to create a digital seismic image, wherein the least-squares reverse time migration includes wave-equation forward modeling based on an asymptotic expression for reflection in a subsurface Kirchhoff integral; and
c. generating a display of the digital seismic image on a graphical user interface.

2. The method of claim 1 wherein the least-squares reverse time migration includes subsurface angle formation by normalized mapping directly from low frequency subsurface offset gathers.

3. The method of claim 1 wherein the least-squares reverse time migration computes the Hessian in a curvelet domain.

4. The method of claim 1 wherein the asymptotic expression is
$$δ G ( ω , r \vert 0 , s ) ∼ \frac{2 π {l}_{0}}{ρ} ( \frac{Δ c}{2 c {cos}^{2} {θ}_{0}} + \frac{Δ ρ}{2 ρ} ) {A}_{s} {A}_{r} {e}^{i ω T ( r , {x}_{0} , s )} .$$

5. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a pre-stack seismic dataset and an earth model;
b. perform least-squares reverse time migration of the pre-stack seismic dataset using the earth model to create a digital seismic image, wherein the least-squares reverse time migration includes wave-equation forward modeling based on an asymptotic expression for reflection in a subsurface Kirchhoff integral; and
c. generate a display of the digital seismic image on a graphical user interface.

6. A non-transitory computer readable storage medium storing one or more programs, the one or more programs comprising instructions, which when executed by an electronic device with one or more processors and memory, cause the device to:
a. receive, at the one or more processors, a pre-stack seismic dataset and an earth model;
b. perform least-squares reverse time migration of the pre-stack seismic dataset using the earth model to create a digital seismic image, wherein the least-squares reverse time migration includes wave-equation forward modeling based on an asymptotic expression for reflection in a subsurface Kirchhoff integral; and
c. generate a display of the digital seismic image on a graphical user interface.
